(19) United States
(12) Patent Application Publication
(10) Pub. No.: US 2007/0107311 A1
(43) Pub. Date: May 17, 2007

(54) Fixing support for vehicle opening frame actuating device

(76) Inventor: Gerard Fournier, Copenhague (FR)

Correspondence Address: Karin H. Butchko;Carlson, Gaskey & Olds, 400 W. Maple Road, Suite 350, Birmingham, MI, 48009, US

(21) Appl. No.: 10/581,839

(22) PCT Filed: Nov. 30, 2004
(86) PCT No.: PCT/FR04/03065

§ 371 Date: Jun. 5, 2006

(30) Foreign Application Priority Data
Dec. 5, 2003 (FR) 0314303

(51) Int. Cl. E05F 15/16

(52) U.S. Cl. 49/349

(57) ABSTRACT

A fixing support assembly comprises a supporting piece and a fixing element (30). The supporting piece comprises a first part (10) and a second part (20) that are essentially planar and parallel. At least one of these parts of said supporting piece comprises at least one retaining member (21) serving to retain an element to be fixed, such as an actuating device of a window lift or of a wing. The fixing element (30) has a nut (31) with a stop (32) serving to ensure the fixing of the support and of the element to be fixed to a wall, for example, in a wing or vehicle body.

### REFERENCE TO RELATED APPLICATION

The application claims priority to PCT Patent Application No. PCT/FR04/03065 filed on Nov. 30, 2004, which claims priority to French Patent Application No. FR 03 14 303 filed on Dec. 5, 2003;

### BACKGROUND OF THE INVENTION

This invention relates generally to a fixing support assembly that makes it possible in particular to fix a window or a door actuating device in a vehicle opening frame. The actuating device is designed to ensure the opening and closing of the window or the opening frame in a vehicle, such as a sunroof, a door or quarter window, or an electric sliding door, for example.

The term “window regulator” will be used hereafter to denote a window opening actuating device, whether for a door, a quarter window, a roof light, or an opening frame, such as a door or a sunroof.

A window regulator in a door is described for example in document U.S. Pat. No. 6,141,910. The window regulator includes a motor driving a drum by a gear. The drum drives movement of a cable that actuates movement of a window along a rail.

For reasons of ease of handling and for protection of the window regulator, the gear and the drum are generally arranged in a module. The module containing the drum and the gear can also include the motor and an electronic unit, or include openings for modular assembly with such components. Such a module is illustrated in document U.S. Pat. No. 6,141,910. The module is closed by three screws arranged around panels of the module surrounding the drum of the window regulator. The three screws make it possible to ensure satisfactory closing around an entire periphery of the module.

The window regulator is designed to be arranged in a vehicle opening frame, for example in a car door, in a roof zone of a vehicle, or in a body component, such as a vehicle's rear quarter panel. The following description, which relates to a vehicle door, can be employed with any opening frame or any rear quarter panel.

Two zones are defined in a vehicle door that are separated by a supporting panel. The zones are a so-called wet zone located towards an outside of the vehicle that is delimited by the body and the supporting panel, and a dry zone located towards an inside of the vehicle that is delimited by a door lining and the supporting panel.

A vehicle door includes numerous electronic and mechanical components, including a window regulator device, a lock and audio equipment, etc. These components are arranged in the door and are generally fixed to the supporting panel either on a dry zone side (in particular for the electronic components) or on a wet zone side (for example, the guide rails and the window actuation cable).

For the window regulator device, it is preferable in certain cases for the drive motor and the electronic unit to be arranged in the dry zone, while the drum and the drive cable of the window are arranged in the wet zone of the door. This arrangement of the window regulator device is in particular described in patent U.S. Pat. No. 6,427,386.

It is then necessary to provide two parts to the window regulator device, namely 1) the drum, the cable with the rails and the window to be arranged in the wet zone and 2) the motor to be arranged in the dry zone. The motor has to drive the drum of the window regulator.

This constraint on the arrangement of the components of the window regulator complicates the mounting of the window regulator actuating device in the door.

The invention proposes a fixing support assembly that makes it possible in particular to simplify the mounting of a window regulator or a door actuating device in a vehicle opening frame.

### SUMMARY OF THE INVENTION

The invention proposes a fixing support assembly including a supporting element having a first part and a second part, which are essentially planar and parallel. At least one of the first part and the second part includes at least one retaining member. The fixing assembly also includes a fixing element having a nut equipped with a stop.

According to one characteristic, at least one of the first part and the second part of the supporting element includes at least one fixing clip. According to one characteristic, one of the first part and the second part of the supporting element includes a housing designed to receive the fixing element. According to one embodiment, the stop of the fixing element is designed to remain captive in the housing. According to one characteristic, the supporting element includes an opening that passes through the supporting element, and which is situated essentially in a center of the supporting element. According to one characteristic, the supporting element is made of molded plastic.

The invention also relates to a vehicle opening frame including a dry zone, a wet zone separated from the dry zone by a supporting panel, and a fixing support assembly according to the invention that is fixed to the supporting panel. The first part of the supporting element is arranged in the wet zone, and the second part of the supporting element is arranged in the dry zone.

According to one characteristic, the opening frame includes a window regulator or a door actuating motor fixed to the second part of the supporting element. According to one embodiment, the motor is retained by at least one retaining member arranged on the second part of the supporting element. According to one embodiment, the motor is fixed to the supporting panel by a single screw cooperating with the fixing element. According to one embodiment, the motor includes a casing having a bore designed to receive the screw and a part of the fixing element. According to one embodiment, the bore includes a first section having a first diameter and a second section having a second diameter greater than the first diameter. The second section of the bore is designed to receive at least one part of the nut of the fixing element. According to one embodiment, the bore also has an alignment section adjacent to the second section.

The invention also relates to a method for mounting a frame actuating motor of a window regulator on a supporting panel of a vehicle opening frame. The panel separates a dry zone from a wet zone, and the method includes the step of fixing a fixing support assembly according to the invention to the supporting panel. A first part of the supporting element is arranged in the wet zone, and a second part of the supporting element is arranged in the dry zone. The method further includes the steps of holding the motor on the second part of the supporting element of the fixing support assembly, adjusting the position of the motor rotatably about a drive axis, and fixing the motor to the supporting panel in a rotation stop position about the drive axis by the fixing element of the fixing support assembly.

According to one characteristic, the step of fixing the motor to the supporting panel is carried out by a screw designed to draw the nut of the fixing element into a bore provided in a casing of the motor.

### BRIEF DESCRIPTION OF THE DRAWINGS

Other characteristics and advantages of the invention will become apparent on reading the following detailed description of the embodiments of the invention, given as an example only and with reference to the drawings, which show:

FIG. 1 shows a diagram of a window regulator actuating device with a fixing support assembly according to the invention;

FIG. 2a shows a diagrammatic view of a fixing element of the assembly in FIG. 1 in a mounted position;

FIG. 2b shows a diagrammatic view of the fixing element of the assembly in FIG. 1 in an immobilization position;

FIG. 3 shows a diagram of a supporting panel including the fixing support assembly according to the invention; and

FIG. 4 shows a diagram of a window regulator actuating motor fixed with the fixing support assembly according to the invention.

### DETAILED DESCRIPTION OF THE PREFERRED EMBODIMENT

According to the invention, a fixing support assembly includes a supporting element and a fixing element. The supporting element includes a first part and a second part, which are essentially planar and parallel. At least one of the first part and the second part of the supporting element includes at least one retaining member designed to retain a component that is to be fixed, for example a window regulator or a door actuating device. The fixing element includes a nut equipped with a stop designed to ensure the fixing of the supporting element and of the component to be fixed to a panel, for example in a vehicle door.

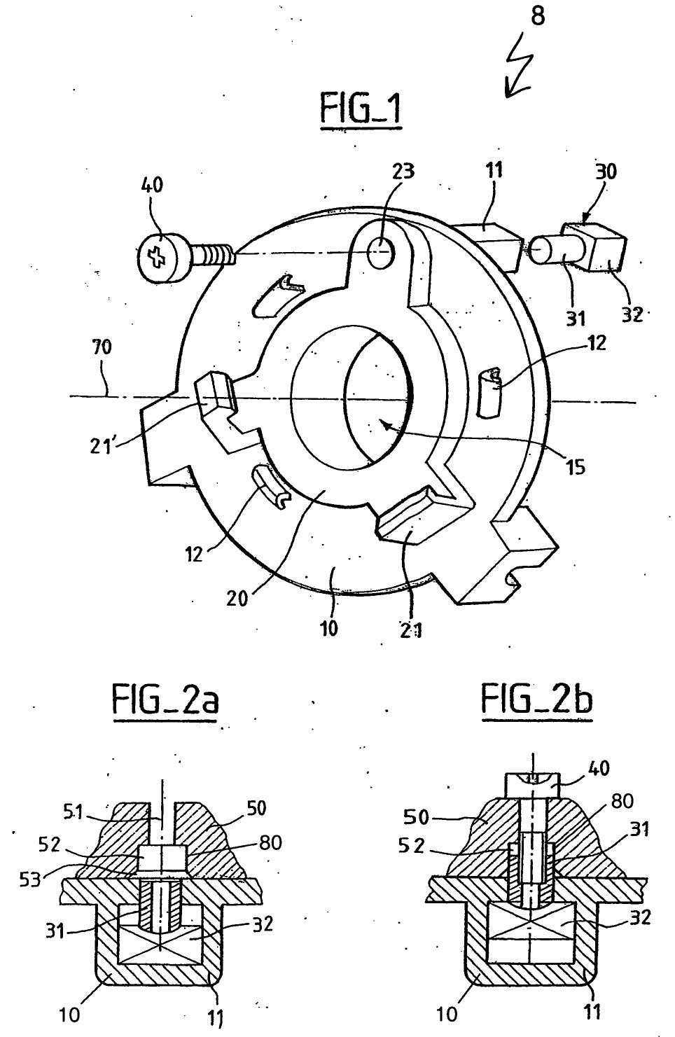

FIG. 1 is a diagram of a fixing support assembly 8 according to the invention. The fixing support assembly 8 includes a supporting element having a first part 10, a second part 20 and a fixing element 30.

The first part 10 and the second part 20 of the supporting element are essentially planar and parallel. The supporting element is designed to be fixed to a panel with a hole through it, with the first part 10 on one side of the panel and the second part 20 on the opposite side of the panel.

The supporting element can be made of molded or machined plastic. The first part 10 and the second part 20 of the supporting element can be made in a single element.

The first part 10 of the supporting element can include fixing clips 12, making it possible to fix the supporting element to the panel. The supporting element can however be fixed to the panel by any other suitable ways, such as screwing or gluing, or a combination of these ways.

The second part 20 of the supporting element includes at least one retaining member, for example two hooks 21 and 21′, designed to retain the component to be fixed. The retaining member can take any other suitable form, for example an arc-shaped groove.

According to one embodiment, the clips 12 and the hooks 21 and 21′ can both be arranged on one of the first part 10 and the second part 20 of the supporting element.

The supporting element can also include an opening 15 that passes through the supporting element, and which is situated essentially in a center of the supporting element. The opening 15 makes it possible to operationally connect the component (such as a window regulator motor, for example) set to the second part 20 of the supporting element to a component arranged on the other side of the panel to which the supporting element is fixed (for example, a cable drive drum). A drive axis 70 can be defined as an axis perpendicular to a plane of the supporting element that passes essentially through the center of the opening 15 in the supporting element.

The fixing support assembly 8 according to the invention also includes a fixing element 30 having a nut 31 equipped with a stop 32. The fixing element 30 is designed to ensure the fixing of the component (such as a motor casing 50) to the second part 20 of the supporting element.

One of the first part 10 and the second part 20 of the supporting element can include a housing 11 designed to receive the fixing element 30. In FIG. 1, the first part 10 includes the housing 11, but it would be equivalent to provide the housing 11 in the second part 20 of the supporting element.

According to one embodiment, the stop 32 of the fixing element 30 can remain captive in the housing 11. The housing 11 includes a screw hole 23 passing through the housing 11 that opens onto a surface of the second part 20 of the supporting element to allow the nut 31 of the fixing element 30 to open on the side of the second part 20. The screw hole 23 is provided in the supporting element according to the invention even in the absence of the housing 11 for the fixing element 30. Preferably, the screw hole 23 passes through the first part 10 and the second 20 part.

By retaining the stop 32 in the housing 11 of the first part 10 of the supporting element, it is possible to retain the fixing element 30 integral with the supporting element, and to pre-position the nut 31 for more rapid fixing of the component to the supporting element.

FIGS. 2a and 2b diagrammatically illustrate the fixing of a component (for example, a gear casing 50) to the supporting element by the fixing element 30. In FIG. 2a, the gear casing 50 is in a fixing position. The nut 31 and the stop 32 of the fixing element 30 are in the housing 11 of the first part 10 of the supporting element. In FIG. 2b, the gear casing 50 is in an immobilization position. The nut 31 has been drawn by a screw 40 into a section 52 of a bore 80 provided in the gear casing 50, while the stop 32 has remained captive in the housing 11.

The gear casing 50 to be fixed by the fixing support assembly 8 according to the invention can advantageously be provided with the bore 80 including sections 51, 52 and 53, making it possible to facilitate the alignment of the element to be fixed with the fixing nut 31. The particular bore 80 provided in the gear casing 50 to be fixed includes a first section 51 having a first diameter d₁ and a second section 52 having a second diameter d₂ greater than the first diameter d₁. The second section 52 of the bore 80 is designed to receive at least one part of the nut 31 of the fixing element 30. The bore 80 can include a widened alignment section 53 adjacent to the second section 52.

The first section 51 of the bore 80 allows for the insertion of the screw 40 that reaches the nut 31. Under the effect of screwing, the screw 40 draws the nut 31 into the second section 52 of the bore 80 until the stop 32 is placed against the screw hole 23.

The fixing support assembly 8 according to the invention can be used particularly advantageously for mounting a window regulator in a vehicle door.

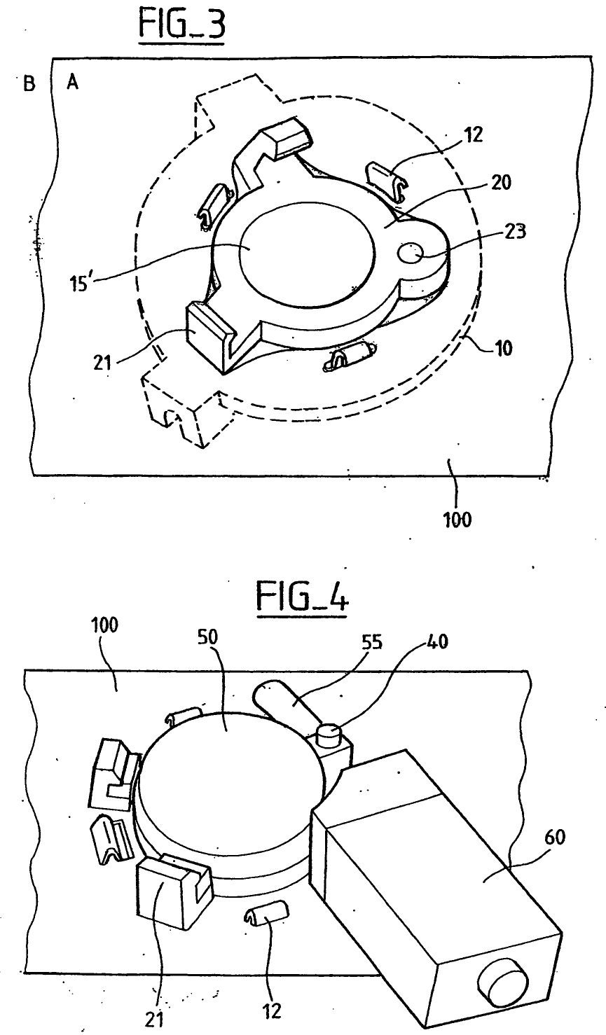

FIG. 3 diagrammatically illustrates a supporting panel 100 forming a separation between a dry zone A and a wet zone B in a vehicle door or a body part, such as a rear quarter panel.

The supporting panel 100 includes an opening 15′ passing through the supporting panel 100, making it possible to slide the supporting element according to the invention to place a first part 10 in the wet zone B and a second part 20 in the dry zone A.

The opening 15′ has dimensions greater than the opening 15 of the supporting element. However, the dimensions of the opening 15′ can be minimized to limit the problems of sealing between the dry zone A and the wet zone B separated by the supporting panel 100.

A motor 60, shown in FIG. 4, can then be fixed to the second part 20 of the supporting element on the side of the dry zone A. The motor 60 can be simply retained by the retaining member(s) 21 of the second part 20 in a partially fixed state. The motor 60 can then be fixed by a single screw 40 that cooperates with the fixing element 30.

In the embodiment illustrated, the retaining members are two hooks 21 and 21′. The screw hole 23 designed to allow the cooperation of the screw 40 with the fixing element 30 can then be provided essentially equidistant from the two hooks 21 and 21′. The motor 60 is thus fixed at three points against the supporting element according to the invention. The fixing fully secures the motor 60 on the supporting panel 100, while allowing easy access for dismantling if necessary. The screw 40 also is situated on the side of the dry zone A of the supporting panel 100.

The motor 60 includes a gear casing 50 with which a worm 55 engages. The gear casing 50 can be machined to have a bore 80 including sections 51, 52 and 53 as described with reference to FIGS. 2a and 2b. The gear casing 50 can also be machined, for example with flat sections, to cooperate with the shape of the hooks 21 and 21′ provided on the second part 20 of the supporting element.

When the gear casing 50 is placed on the second part 20 of the supporting element and retained by the hooks 21 and 21′, the centering does not have to be perfect. The gear casing 50 can be turned about a drive axis 70 to position a widened section 53 of the bore 80 opposite the screw hole 23 of the supporting element.

The screw 40 is then introduced into a first section 51 of the bore 80. When the nut 31 has been drawn into a second section 52 of the bore 80, the motor 60 can no longer rotate freely about the drive axis 70. The screw 40 and the nut 31 are then tightened to place the stop 32 against the supporting element and to remove any degree of freedom from the gear casing 50 of the motor 60.

The location of the sections 51, 52 and 53 of the bore 80 on the gear casing 50 also allows for the satisfactory positioning of an axis of the motor 60 relative to the drive axis 70. The drive axis 70 coincides with a drive axis of a drum also designed to be fixed to the element in the wet zone B. An axle spread between the drive axis 70 of the drum and the axis of the worm 55 of the motor 60 can therefore be well controlled. Preferably, the bore 80 of the gear casing 50 is proximate to the worm 55 of the motor 60.

Moreover, the nut 31 allows for the reaction torque of the motor 60 in operation to be withstood. A window regulator motor applies approximately 3 m/N of reaction to the element to which it is fixed. With time, this reaction torque can cause play in the attachment of the supporting element. Within the scope of this invention, this reaction torque is absorbed by the screw 40 and the nut 31, and the screw threads of which are such that the reaction torque contributes to the tightening of the fixing. The stop 32 is therefore held in the immobilization position (FIG. 2b) during the operation of the motor 60.

Of course, this invention is not limited to the embodiments described as an example. Thus, the shapes of the fixing supporting element and its location can vary depending on the components to be fixed and their arrangement in the dry zone and the wet zone of a vehicle door or rear quarter panel.

In particular, the invention has been described with a fixing element situated in the wet zone and screwing from the dry zone, but the reverse can also be implemented without exceeding the scope of the invention. In general, the terms first and second parts in the description can be reversed without exceeding the scope of the invention.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A fixing support assembly comprising:
a supporting element including a first part and a second part, which are substantially planar and parallel, wherein at least one of the first part and the second part includes at least one retaining member and
a fixing element including a nut having a stop.

2. The fixing support assembly according to claim 1, wherein at least one of the first part and the second part of the supporting element includes at least one fixing clip.

3. The fixing support assembly according to claim 1, wherein one of the first part and the second part of the supporting element includes a housing to receive the fixing element.

4. The fixing support assembly according to claim 3, wherein the stop of the fixing element remains captive in the housing.

5. The fixing support assembly according to claim 1, wherein the supporting element includes an opening that passes through the supporting element and that is situated substantially in a center of the supporting element.

6. The fixing support assembly according to claim 1, wherein the supporting element is made from molded plastic.

7. A vehicle opening frame comprising:
a dry zone;
a wet zone separated from the dry zone by a supporting panel; and
a fixing support assembly fixed to the supporting panel, the fixing support assembly including:
a supporting element including a first part and a second part which are substantially planar and parallel, wherein at least one of the first part and the second part includes at least one retaining member, and
a fixing element including a nut equipped with a stop,
wherein the first part is arranged in the wet zone and the second part arranged in the dry zone.

8. The vehicle opening frame according to claim 7, further including at least one of a window regulator and a door actuating motor fixed to the second part of the supporting element.

9. The vehicle opening frame according to claim 8, including the door actuating motor, wherein the door actuating motor is retained by the at least one retaining member arranged on the second part of the supporting element.

10. The vehicle opening frame according to claim 8, including the door actuating motor, wherein the door actuating motor is fixed to the supporting panel by a single screw that cooperates with the fixing element.

11. The vehicle opening frame according to claim 10, wherein the door actuating motor includes a casing having a bore to receive the single screw and a part of the fixing element.

12. The vehicle opening frame according to claim 11, wherein the bore includes a first section having a first diameter and a second section having a second diameter greater than the first diameter, wherein the second section of the bore receives at least one part of the nut of the fixing element.

13. The vehicle opening frame according to claim 12, wherein the bore includes an alignment section adjacent to the second section.

14. A method of mounting a frame actuating motor of a window regulator on a supporting panel of a vehicle opening frame, the supporting panel separating a dry zone from a wet zone, the method comprising the steps of:
fixing a fixing support assembly including a supporting element and a fixing element on the supporting panel, wherein a first part of the supporting element is arranged in the wet zone and a second part of the supporting element is arranged in the dry zone;
holding the frame actuating motor on the second part of the supporting element;
adjusting a position of the frame actuating motor rotatably about a drive axis; and
fixing the frame actuating motor to the supporting panel in a rotation stop position by the fixing element, wherein the first part and the second part are substantially planar and parallel, at least one of the first part and the second part includes at least one retaining member, and the fixing element includes a nut equipped with a stop.

15. The method according to claim 14, wherein the step of fixing the frame actuating motor to the supporting panel is performed by a screw that draws the nut of the fixing element into a bore in a casing of the frame actuating motor.
